(19) United States
(12) Patent Application Publication
(10) Pub. No.: US 2024/0282001 A1
(43) Pub. Date: Aug. 22, 2024

(54) METHOD AND DEVICE FOR DETERMINING A MAP OF A THREE-DIMENSIONAL ENVIRONMENT AND ASSOCIATED MAPPING SYSTEM

(71) Applicant: FONDATION B-COM, CESSON-SEVIGNE (FR)

(72) Inventors: Mathieu GONZALEZ, VITRÉ (FR); Eric MARCHAND, CESSON SEVIGNÉ (FR); Amine KACETE, RENNES (FR); Jérôme ROYAN, SAINT-MÉDARD SUR ILLE (FR)

(21) Appl. No.: 18/573,226

(22) PCT Filed: Jun. 23, 2022
(86) PCT No.: PCT/EP2022/067104

§ 371 Date: Dec. 21, 2023

(30) Foreign Application Priority Data
Jun. 25, 2021 (FR) FR2106820

(51) Int. Cl. G06T 7/73; G06T 7/579; G06V 10/764; G06V 10/82

(52) U.S. Cl. CPC G06T 7/73; G06T 7/579; G06V 10/764; G06V 10/82; G06T 2200/04; G06T 2207/20084

(57) ABSTRACT

A device, a mapping system, and a method for determining a map of a three-dimensional environment including objects determine common characteristic elements in first and second images of the environment, determine groups of characteristic elements by an image analysis such that each group of characteristic elements corresponds to an object of the environment, estimate a three-dimensional position of the characteristic elements based on a triangulation between positions of the characteristic elements in the first image and positions of the corresponding characteristic elements in the second image, and, for each group of characteristic elements, optimize the three-dimensional positions of the characteristic elements of the respective group by minimizing an error variable which is a function, for all the characteristic elements of the group, of a distance between a detected position of the characteristic elements from at least the first image and a two-dimensional position associated with the corresponding estimated three-dimensional position.

### TECHNICAL FIELD OF THE INVENTION

The present invention relates to the technical field of simultaneous location and mapping of electronic equipment in a three-dimensional environment.

In particularly, it relates to a method and a device for determining a map of a three-dimensional environment and an associated mapping system.

### STATE OF THE ART

SLAM (“Simultaneous Localization and Mapping”) systems are known to enable simultaneous location and mapping of a mobile equipped with an image-acquisition device, for example a camera, in an three-dimensional environment.

Conventionally, such a system is based on an analysis of the images acquired by the camera. More particularly, points of the last image acquired are mapped with the corresponding points of the previously acquired images. A triangulation is then made in order to obtain both a three-dimensional representation of the environment concerned and the pose of the image acquisition device in this environment. An optimization (also called “Bundle adjustment”) enables to refine the position of the points forming the three-dimensional representation.

However, this optimization step is rather complex and expensive to implement because it requires the analysis of all the points of the images acquired.

### DISCLOSURE OF THE INVENTION

In this context, the present invention proposes to improve the determination of the three-dimensional environment map, and in particular to improve the optimization step.

More particularly, it is proposed, according to the invention, a method for determining a map of a three-dimensional environment, comprising a plurality of objects, on the basis of at least a first image and a second image of said three-dimensional environment, said first image and said second image being respectively acquired by an image-acquisition device having two different poses, the method comprising the steps of:
determining a plurality of common characteristic elements in the first image and the second image of said three-dimensional environment,
determining groups of characteristic elements by means of an image analysis in such a way that each group of characteristic elements corresponds to an object of the three-dimensional environment,
estimating a three-dimensional position of the characteristic elements on the basis of a triangulation between the positions of the characteristic elements in the first image and the positions of the corresponding characteristic elements in the second image, and
for each group of characteristic elements, optimizing the three-dimensional positions of the characteristic elements of the group concerned by minimizing an error variable that is function, for all the characteristic elements of the group concerned, of a distance between a detected position of said characteristic elements from at least the first image and a two-dimensional position associated with the corresponding estimated three-dimensional position.

Thus, advantageously, the three-dimensional positions are optimized, in a first time, for identified groups of elements and not for all the characteristic elements of the image. This enables to simplify this optimization and to reduce the required processing time. The three-dimensional environment map can thus be obtained more rapidly.

Other non-limiting and advantageous features of the method according to the invention, taken individually or according to all the technically possible combinations, are the following:
the step of estimating the three-dimensional position of the characteristic elements is implemented for each group of characteristic elements on the basis, for each group of characteristic elements, of a triangulation between the positions of the characteristic elements of the group concerned in the first image and the positions of the corresponding characteristic elements in the second image;
the determination of characteristic elements uses a method of identifying distinctive areas corresponding to shapes present in the first image and in the second image;
the identification of the groups of characteristic elements uses a neural network receiving as an input an image of the three-dimensional environment and outputting a class for each of the pixels of the image concerned, which enables to obtain a classification of said pixels;
the groups of characteristic elements are obtained from classes allocated to the characteristic elements, for example by using, for each characteristic element, the class provided by the neural network for the corresponding pixel;
after the step of determining the optimized three-dimensional positions, another step is provided of optimizing, for all the characteristic elements identified, the optimized three-dimensional position on the basis of a minimization of an error variable that is function, for all the characteristic elements identified, of a distance between the detected position of said characteristic elements from at least the first image and a two-dimensional position associated with the corresponding optimized three-dimensional position;
the estimation step comprises a sub-step of determining a pose of the image-acquisition device;
the two-dimensional position (as used in either one of the optimization steps) is also associated with the determined pose of the image-acquisition device;
a step is provided of selecting groups of characteristic elements on the basis of the nature of the associated objects, the step of determining the optimized three-dimensional positions being implemented only for the characteristic elements of the selected groups;
the step of determining the optimized three-dimensional positions comprising a sub-step of identifying a type of object, the error variable is minimized as a function of the type of object identified for the concerned group of characteristic elements; and
the error variable is minimized as a function of a geometric feature associated with the object concerned.

Therefore, if the concerned object is flat, this geometric feature is taken into account for the optimization and this also enables a faster processing.

The present invention relates to a device for determining a map of a three-dimensional environment, comprising a plurality of objects, on the basis of at least a first image and a second image of said three-dimensional environment, said first image and said second image being respectively acquired by an image-acquisition device having two different poses, the determination device comprising:
a module for determining a plurality of common characteristic elements in the first image and the second image of said three-dimensional environment,
a module for determining groups of characteristic elements by means of an image analysis in such a way that each group of characteristic elements corresponds to an object of the three-dimensional environment,
a module for estimating a three-dimensional position of the characteristic elements on the basis of a triangulation between the positions of the characteristic elements of the group concerned in the first image and the positions of the corresponding characteristic elements in the second image, and
a module for optimizing, for each group of characteristic elements, the three-dimensional positions of the characteristic elements of the group concerned by minimizing an error variable that is function, for all the characteristic elements of the group concerned, of a distance between a detected position of said characteristic elements from at least the first image and a two-dimensional position associated with the corresponding estimated three-dimensional position.

The present invention also relates to a three-dimensional environment mapping system comprising a device for determining a map of a three-dimensional environment as introduced hereinabove and an image-acquisition device.

Of course, the different features, alternatives and embodiments of the invention can be associated with each other according to various combinations, insofar as they are not mutually incompatible or exclusive.

### DETAILED DESCRIPTION OF THE INVENTION

Moreover, various other features of the invention will be apparent from the appended description made with reference to the drawings that illustrate non-limiting embodiments of the invention, and wherein:

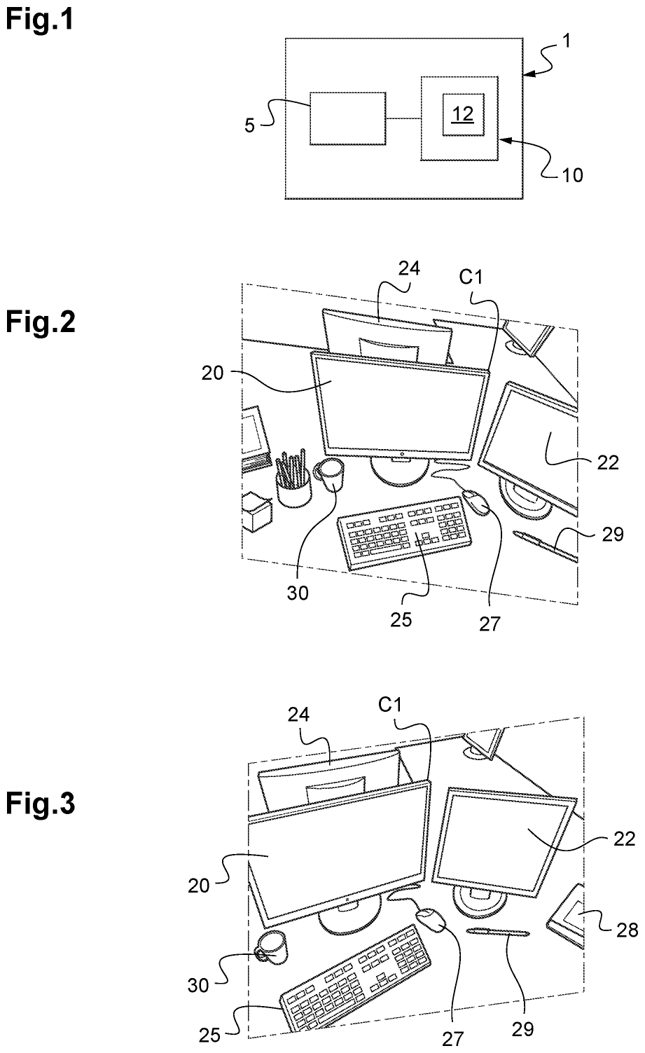

FIG. 1 schematically shows the main elements of a three-dimensional environment mapping system in accordance with the invention,

FIG. 2 shows a first image of a three-dimensional environment according to a first pose of an image-acquisition device,

FIG. 3 shows a second image of a three-dimensional environment according to a second pose of the image-acquisition device,

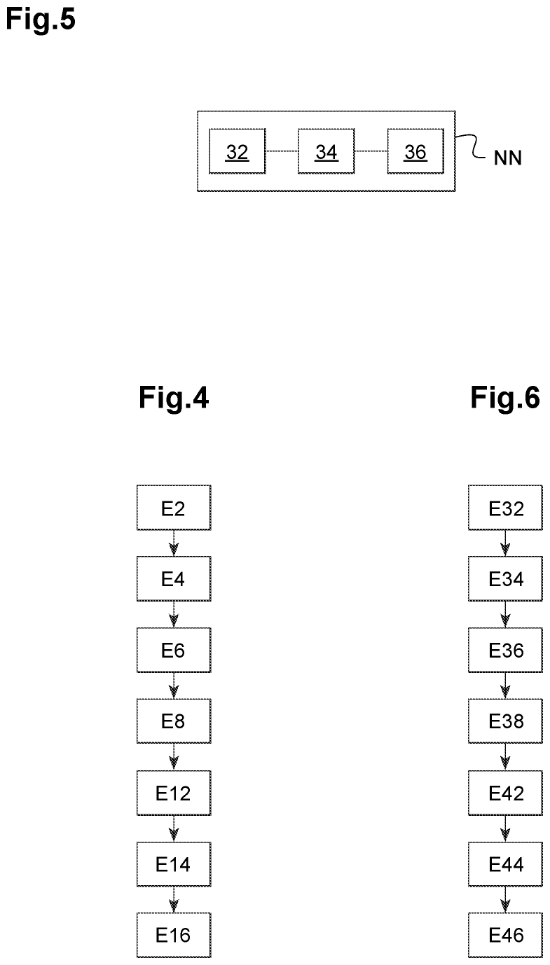

FIG. 4 shows, as a flowchart, a first example of a three-dimensional environment map determination method according to the invention,

FIG. 5 shows an example of a neural network used in the mapping system of FIG. 2, and

FIG. 6 shows, as a flowchart, a second example of a three-dimensional environment map determination method according to the invention.

It is to be noted that, in these figures, the structural and/or functional elements common to the different alternatives can have the same references.

FIG. 1 shows the main elements of a three-dimensional environment mapping system 1 in accordance with the invention.

The mapping system 1 comprises an image-acquisition device 5 and a device 10 for determining a map of the three-dimensional environment.

The image-acquisition device 5 is designed to acquire at least one image of the three-dimensional environment of interest. In practice, the image-acquisition device 5 is for example an RGB monocular camera for acquiring images of the three-dimensional environment.

FIGS. 2 and 3 respectively show a first image and a second image of a three-dimensional environment, acquired by the image-acquisition device 5. The first image and the second image are acquired for two different poses of the image-acquisition device 5. By definition, the pose of the image-acquisition device 5 is defined according to six degrees of freedom (three degrees of rotation and three degrees of translation).

As shown in FIGS. 2 and 3, the three-dimensional environment comprises a plurality of objects. Here, this three-dimensional environment comprises in particular three screens 20, 22, 24, a keyboard 25, a computer mouse 27, a book 28, a pen 29 and a cup 30.

As can be seen in FIGS. 2 and 3, some objects are shown in the first image and not in the second image, or the reverse, this depending on the pose of the image-acquisition device 5. For example, the book 28 is visible in the second image and not in the first image.

The map-determination device 10 is designed to process the images acquired by the image-acquisition device 5. For that purpose, the map-determination device 10 comprises a calculator 12. This calculator 12 includes a processor, for example a microprocessor, and an internal memory. The internal memory stores in particular 30 computer program instructions. These computer program instructions enable, when they are executed by the processor, the implementation by the calculator 12 of some functions such as the implementation of a three-dimensional environment map determination method described hereinafter with reference to FIGS. 4 and 6. In particular, the calculator 12 is for example designed to implement a neural network NN, intervening in the three-dimensional environment map determination method described hereinafter.

FIG. 4 shows, as a flowchart, a first example of a three-dimensional environment map determination method implemented by the calculator 12.

This method starts with step E2, in which the image-acquisition device 5 acquires a plurality of images of the three-dimensional environment. Each image of the plurality of images is acquired for a different pose of the image-acquisition device.

In the example shown hereinafter, at step E2, the image-acquisition device acquires the first image, shown for example in FIG. 2, and the second image, shown in FIG. 3.

The images acquired by the image-acquisition device 5 are then processed by the calculator 12 of the map-determination device 10.

In particular, in step E4, the calculator 12 determines a plurality of characteristic elements present in the images acquired at step E2. As used here, “characteristic elements” means pixels of the image comprising characteristic shapes.

In practice, the calculator 12 uses an identification method, in the images acquired at step E2, of distinctive areas corresponding to shapes present in the image analyzed. This identification method is for example an ORB (“Oriented Fast and Rotated BRIEF”) method. More detail about this method are available in the article “ORB: an efficient alternative to SIFT or SURF” by E. Rublee, V. Rabaud, K. Konolige and G. Bradski, 2011 International Conference on Computer Vision, pp. 2564-2571, doi: 10.1109/ICCV.2011.6126544, 2011.

For example, in this step, the calculator 12 identifies the corners or edges present in the image concerned. These characteristic elements are then for example characteristic points of the image or characteristic segments of the image.

Considering the first image and the second image represented in FIGS. 1 and 2, respectively, in step E4, the calculator 12 determines the characteristic elements common to these two images. Here, more particularly, the calculator 12 here identifies as characteristic points the corners of the screens 20, 22, 24 or the ends of the pen 29. The calculator 12 also determines, as characteristic segments, the long body of the pen 29, the lateral sides of the screens 20, 22, 24 or the lateral sides of the keyboard 25. However, the calculator 12 does not identify here the corners or the lateral sides of the book 28 because the book is here not visible in the first image. Only the characteristic elements common to the first image and the second image are determined here.

As shown in FIG. 4, the method then continues with step E6. According to this first example of the method, in this step, the calculator 12 determines groups of characteristic elements. Each group of characteristic elements normally corresponds in practice to an object of the three-dimensional environment.

In the example described here, the identification of the groups of characteristic elements is implemented by means of at least one neural network NN.

The calculator 12 provides, at the input of this neural network NN, an image acquired by the image-acquisition device 5 at step E2. This neural network NN is designed to output, for each pixel of the image concerned, a class associated with an object of the three-dimensional environment.

This neural network NN has hence a function of image pixel classification relating to the objects present in the three-dimensional environment. In particular, this classification function applies to the characteristic elements determined at step E4, then leading to the determination of groups of characteristic elements, each group corresponding to a class (i.e., in practice, associated with an object of the three-dimensional environment).

In practice, the neural network NN here comprises three parts 32, 34, 36 (FIG. 5). Each part 32, 34, 36 comprises several tens of layers of neurons, typically between 50 and 100 layers of neurons for each part 32, 34, 36.

The first part 32 is designed to extract the distinctive areas from the image concerned. The second part 34 and the third part 36 are designed to generate groups in the image from the distinctive areas extracted by the first part 32. These second part 34 and third part 36 thus enable to generate the classification of the image pixels. More particularly, the second part 34 enable classifying the so-called “uncountable” elements, such as for example a “sky” element or a “road” element, from so-called “countable” elements, such as a “car” element. However, for the countable elements, this second part 34 is not adapted to separate them on an individual basis. For example, the second part 34 identifies an area comprising cars but cannot distinguish cars from each other.

The third part 36 then enables to refine the classification by distinguishing the countable elements from each other in a distinctive area extracted by the first part 32. For example, after identification of the “cars” area, the third part 36 is designed to differentiate the cars from each other in this area.

Such a neural network is described for example in the article “Panoptic Feature Pyramid Networks”, by A. Kirillov, R. Girshick, K. He, P. Dollar, 6392-6401. 10.1109/CVPR.2019.00656, 2019.

Previously to the implementation of the determination method, a learning step (not shown in the figures) enables the training of this neural network NN. For that purpose, a set of basic image is used. For each basic image of this set, each pixel is associated in a predetermined manner with an object of the three-dimensional environment, i.e. in practice to a class corresponding to this object. The neuron weights are then adjusted as the learning step progresses.

As an alternative, a neural network can be used in combination with an algorithm. In this case, the neural network outputs for example sets of pixels of the image that are associated with the different objects of the three-dimensional environment. These sets of pixels obtained as an output are then analyzed separately by an algorithm in order to extract the characteristic elements in each of the sets of pixels. This then enables to obtain the groups of characteristic elements.

Therefore, at the end of step E6, the calculator has identified groups of characteristic elements that correspond to the different objects of the three-dimensional environment.

Therefore, considering the examples of FIGS. 2 and 3, at the end of step E6, the calculator 12 determines for example a group of characteristic elements associated with a first screen 20, another group associated with a second screen 22 or still another group of characteristic elements associated with the keyboard 25. However, the calculator 12 identifies no group of characteristic elements associated with the book 29 because the latter is not visible in the first image.

The method then comprises the step E8 in which the calculator 12 estimates a three-dimensional position of each characteristic data determined at step E4. In this first example of the method, this estimation is made per group of characteristic elements identified at step E6.

The three-dimensional position of each characteristic data of each identified group is determined by means of a triangulation between the different positions of the characteristic data concerned (of the corresponding group) over a plurality of images acquired by the image-acquisition device 5 at step E2.

For example, considering the corner C1 of the screen 20 (FIGS. 2 and 3), the three-dimensional position is estimated from the position of the corner C1 in the first image and the position of this same corner C1 in the second image.

In parallel with this estimation of the three-dimensional positions of characteristic elements, the calculator 12 also determines the pose of the image-acquisition device 5 on the basis of all the characteristic elements identified at step E8. In practice, the pose of the image-acquisition device 5 is determined by optimization of a cost function. This cost function minimizes a distance between the positions of the characteristic elements on each of the images acquired by the image-acquisition device 5 at step E2 and the two-dimensional positions associated with the previously estimated three-dimensional positions of the characteristic elements.

More precisely, the calculator 12 determines a two-dimensional projection function that considers, as input variables, the previously estimated three-dimensional positions of the elements and the pose of the image-acquisition device 5. The two-dimensional projection function then provides, as a result, the two-dimensional positions of the characteristic elements concerned. In practice, the calculator 12 varies the pose of the image-acquisition device 5 and searches for the values of this position that minimize the distance between the two-dimensional positions produced by the projection function and the two-dimensional positions observed on the images acquired at step E2.

As shown in FIG. 4, the method then continues with step E12. In this step, for each group of characteristic elements identified at step E6, the calculator 12 implements a step of optimizing the three-dimensional positions of the characteristic elements of the group concerned and determined at step E8.

For that purpose, the calculator 12 determines the distance, previously introduced, between the positions of the characteristic elements concerned (of the corresponding group) on each of the images acquired by the image-acquisition device 5 at step E2 and the two-dimensional positions associated with the previously estimated three-dimensional positions of the characteristic elements (in the group concerned). In other words, here, this distance is determined only for the characteristic elements of the group concerned.

More precisely, the calculator 12 also determines here the two-dimensional projection function that considers, as input variables, the previously estimated three-dimensional positions of the characteristic elements of the group concerned and the pose of the image-acquisition device 5. The two-dimensional projection function then provides, as a result, the two-dimensional positions of the characteristic elements concerned (of the corresponding group). In practice, the calculator 12 thus here varies the determined three-dimensional positions and pose of the image-acquisition device 5 and searches for the values of these quantities that minimize the distance between the two-dimensional positions produced by the projection function and the two-dimensional positions observed on the images acquired at step E2.

Therefore, the optimization step consists in minimizing, for all the characteristic elements of a group concerned, an error variable that is function of the distance between the positions of the characteristic elements concerned (of the corresponding group) on each of the images acquired by the image-acquisition device 5 at step E2 and two-dimensional positions associated with the three-dimensional positions of the characteristic elements (in the group concerned).

At the end of step E12, the calculator 12 then determines optimized three-dimensional positions on the basis of the minimized error value. The pose of the image-acquisition device 5 is also optimized in this step E12.

The method then comprises step E14. In this step, the calculator 12 implements another optimization step, this time for all the characteristic elements determined at step E4 (and not only the characteristic elements of each group identified at step E6). This other optimization step aims to refine the optimize three-dimensional positions obtained at the end of step E12.

This other optimization step is implemented in the same way as the optimization step E12, by minimizing the error variable that is function of the distance between the positions of the characteristic elements on each of the images acquired by the image-acquisition device 5 at step E2 and the two-dimensional positions associated with the optimized three-dimensional positions of the characteristic elements. This other optimization step is lightened thanks to the processing performed in the previously implemented optimization step (step E12).

At the end of step E14, the calculator 12 then determines refined three-dimensional positions. The pose of the image-acquisition device 5 is also optimized again in this step E14.

The calculator 12 finally determines a map of the three-dimensional environment on the basis of the refined three-dimensional positions and the pose of the image-acquisition device 5 (step E16).

FIG. 6 shows, as a flowchart, a second example of a three-dimensional environment map determination method implemented by the calculator 12.

In this second example, the method starts with step E32, in which, similarly to step E2 described hereinabove, the image-acquisition device 5 acquires a plurality of images of the three-dimensional environment. Each image of the plurality of images is acquired for a different pose of the image-acquisition device.

At step E34, similarly to step E4, the calculator 12 determines a plurality of characteristic elements present in the images acquired at step E2.

As can be seen in FIG. 6, the method then continues with step E36. In this step, the calculator 12 estimates a three-dimensional position of each characteristic data determined at step E34. In this second example of the method, this estimation is made for all the characteristic elements identified at step E34. In other words, step E36 is similar to the above-described step E8, but step E36 is implemented for all the characteristic elements (and not only of the characteristic elements of the identified groups).

In this second example, the method continues with step E38 in which the calculator 12 determines groups of characteristic elements. As in step E6 of the first example of the method, each group of characteristic elements is associated with an object of the three-dimensional environment by means of the images here acquired in step E32.

Steps E42 and E44 then enable optimizing the three-dimensional positions determined at step E36 in a similar way as described hereinabove in the steps E12 and E14.

Finally, as in step E16, the calculator 12 finally determines a map of the three-dimensional environment on the basis of the refined three-dimensional positions and the pose of the image-acquisition device 5 (step E46).

Finally, this second example of the method is similar to the first example described hereinabove, the only differences resulting into an inversion and an adjustment of steps E6 and E8 into steps E36 and E38.

As an alternative (for the first and second examples of the method), the step of determining optimized three-dimensional positions (step E12 and E32) has, previously to minimizing the error variable, a step of identifying the types of objects associated with the different groups determined. For that purpose, the calculator 12 memorizes for example a database of a plurality of objects with the characteristics thereof.

For example, this database lists the geometric features of the different objects. For example, a planar characteristic will be associated with the “book” object.

The error variable minimization method is then adapted to the type of object. For example, this minimization may be function of the geometric features of the object concerned.

As another alternative (for the first and the second example of the method), the method can comprise, after the step of determining the groups of characteristic elements, a step of selecting certain groups determined as a function of the nature of the objects with which they are associated.

As used here, “nature of the objects” means for example whether the object is static or dynamic. The ground or the sky are for example so-called static objects. For example, only the so-called dynamic objects are selected for the optimization step.

In this alternative, the optimization step (step E10 or E40) is then implemented for the characteristic elements of the selected groups. The optimized three-dimensional positions are hence determined for these characteristic elements of the selected groups.

1. A method for determining a map of a three-dimensional environment including a plurality of objects based on at least a first image and a second image of said three-dimensional environment, said first image and said second image being respectively acquired by an image-acquisition device having two different poses, the method comprising:
determining a plurality of common characteristic elements in the first image and the second image of said three-dimensional environment;
determining groups of the characteristic elements by an image analysis such that each of the groups of the characteristic elements corresponds to an object of the three-dimensional environment;
estimating a three-dimensional position of the characteristic elements based on a triangulation between the positions of the characteristic elements in the first image and the positions of the corresponding characteristic elements in the second image, the estimating comprising determining one of the poses of the image-acquisition device; and
for each of the groups of the characteristic elements, optimizing the three-dimensional positions of the characteristic elements of the respective group by minimizing an error variable that is a function, for all the characteristic elements of the respective group, of a distance between a detected position of said characteristic elements from at least the first image and a two-dimensional position obtained by application of a projection function to the corresponding estimated three-dimensional position and determine the map of the three-dimensional environment using the optimized three-dimensional positions of the characteristic elements of the respective group.

2. The method according to claim 1, wherein the estimating the three-dimensional position of the characteristic elements is implemented for each of the groups of the characteristic elements based on, for each of the groups of the characteristic elements, the triangulation between the positions of the characteristic elements of the respective group in the first image and the positions of the corresponding characteristic elements in the second image.

3. The method according to claim 1, wherein the determining the characteristic elements uses a method of identifying distinctive areas corresponding to shapes present in the first image and the second image.

4. The method according to claim 1, wherein the determining the groups of the characteristic elements uses a neural network (NN) receiving as an input one or more of the first image and the second image of the three-dimensional environment and outputting a class for each of the pixels of the respective image.

5. The method according to claim 4, wherein the groups of the characteristic elements are obtained from the classes allocated to the characteristic elements.

6. The method according to claim 1, further comprising, after the optimizing the three-dimensional positions, further optimizing, for all the determined characteristic elements, the optimized three-dimensional position based on a minimization of an error variable that is a function, for all the determined characteristic elements, of a distance between the detected position of said characteristic elements from at least the first image and a two-dimensional position associated with the corresponding optimized three-dimensional position.

7. The method according to claim 1, further comprising selecting groups of the characteristic elements based on the nature of the associated objects, the determining the optimized three-dimensional positions being implemented only for the characteristic elements of the selected groups.

8. The method according to claim 1, wherein, of determining the optimized three-dimensional positions comprises identifying a type of object, the error variable being minimized as a function of the type of object identified for the respective group of the characteristic elements.

9. The method according to claim 8, wherein the error variable is minimized as a function of a geometric feature associated with the respective object.

10. A device for determining a map of a three-dimensional environment, including a plurality of objects based on at least a first image and a second image of said three-dimensional environment, said first image and said second image being respectively acquired by an image-acquisition device having two different poses, the determination device comprising:
at least one processor configured to:
determine a plurality of common characteristic elements in the first image and the second image of said three-dimensional environment,
determine groups of characteristic elements by an image analysis such that each of the groups of the characteristic elements corresponds to an object of the three-dimensional environment,
estimate a three-dimensional position of the characteristic elements based on a triangulation between the positions of the characteristic elements of the respective group in the first image and the positions of the corresponding characteristic elements in the second image, with determination of one of the poses of the image-acquisition device, and
optimize, for each of the groups of the characteristic elements, the three-dimensional positions of the characteristic elements of the respective group by minimizing an error variable that is a function, for all the characteristic elements of the respective group, of a distance between a detected position of said characteristic elements from at least the first image and a two-dimensional position obtained by application of a projection function to the corresponding estimated three-dimensional position and determine the map of the three-dimensional environment using the optimized three-dimensional positions of the characteristic elements of the respective group.

11. A three-dimensional environment mapping system comprising:
the device for determining the map of the three-dimensional environment according to claim 10; and
an image-acquisition device.

12. The method according to claim 2, wherein the determining the characteristic elements uses a method of identifying distinctive areas corresponding to shapes present in the first image and the second image.

13. The method according to claim 2, wherein the determining the groups of the characteristic elements uses a neural network (NN) receiving as an input one or more of the first image and the second image of the three-dimensional environment and outputting a class for each of the pixels of the respective image.

14. The method according to claim 3, wherein the determining the groups of the characteristic elements uses a neural network (NN) receiving as an input one or more of the first image and the second image of the three-dimensional environment and outputting a class for each of the pixels of the respective image.

15. The method according to claim 2, further comprising, after the optimizing the three-dimensional positions, further optimizing, for all the determined characteristic elements, the optimized three-dimensional position based on a minimization of an error variable that is a function, for all the determined characteristic elements, of a distance between the detected position of said characteristic elements from at least the first image and a two-dimensional position the corresponding optimized three-dimensional position.

16. The method according to claim 2, further comprising selecting groups of the characteristic elements based on the nature of the associated objects, the determining the optimized three-dimensional positions being implemented only for the characteristic elements of the selected groups.

17. The method according to claim 2, wherein, the determining the optimized three-dimensional positions comprises identifying a type of object, the error variable being minimized as a function of the type of object identified for the respective group of the characteristic elements.
